(19) United States
(12) Patent Application Publication
(10) Pub. No.: US 2005/0126187 A1
(43) Pub. Date: Jun. 16, 2005

(54) Cryogenic cooling apparatus

(76) Inventors: Rui Li, Saitama (JP); Yuki Ikushima, Saitama (JP); Toshikazu Suzuki, Ibaraki (JP); Takayuki Tomaru, Gumma (JP); Takakazu Shintomi, Ibaraki (JP); Tomiyoshi Haruyama, Ibaraki (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/875,173

(22) Filed: Jun. 25, 2004

(30) Foreign Application Priority Data
Jul. 3, 2003 (JP) 2003-190886

(51) Int. Cl. F25B 9/00; F17C 5/02

(52) U.S. Cl. 62/6

(57) ABSTRACT

A cold head of a refrigerator is secured to a support stage provided separately from a cryostat so that the support stage supports the load of the cold head. On the other hand, a low-vibration stage for supporting a load of an object to be cooled is secured to a top flange of the cryostat. Thus, vibration that occurs due to the refrigerator is prevented from being transmitted to the entire cryostat and the object to be cooled.

### BACKGROUND OF THE INVENTION

1. Field of the Invention

The present invention relates to a cryogenic cooling apparatus including a cryostat cooled by a refrigerator. More particularly, the present invention relates to a cryogenic cooling apparatus which can prevent vibration generated by the refrigerator from being transmitted to the entire cryostat or an object to be cooled and is suitable for a Gifford-McMahon type (GM) pulse tube refrigerator or a Gifford-McMahon cycle refrigerator (GM refrigerator) in which a valve unit can be separated from a cold head.

2. Description of the Related Art

In a cryogenic cooling apparatus including a cryostat cooled by using a refrigerator, several kinds of vibration typically caused by the refrigerator occurs and is transmitted to the entire cryostat and an object to be cooled. More specifically, a compressor serving as a source of pressure oscillation is mechanical type. Thus, mechanical vibration from that compressor is transmitted to a cold head that is a cooling portion attached to the cryostat through an interconnecting tube for connecting the compressor and the cold head, thereby affecting the entire cryostat. Moreover, in a case of a refrigerator including a piston (also referred to as a displacer) within the cold head, such as a GM refrigerator or a Stirling refrigerator, reciprocating motion of the piston involved with compression and expansion causes cyclic vibration which is transmitted to the entire cryostat and the object to be cooled. Furthermore, since a cylinder of the refrigerator typically has a cylindrical thin structure, pressure oscillation between a higher pressure and a lower pressure in the cold head involved with compression/expansion causes elastic expansion and contraction of the cylinder, providing further vibration to the object to be cooled.

In order to overcome the aforementioned drawbacks, Japanese Patent Laid-Open Publication No. Hei 9-50910 (Patent Document 1) describes that (1) in a superconducting coil cooling apparatus, a superconducting coil, that is an object to be cooled, is coupled to a cooling stage of a refrigerator via a vibration-absorbing member, thereby absorbing vibration from the cooling stage. The vibration-absorbing member is formed of metal having excellent heat conductance, that is formed by braided wires obtained by braiding finer copper wires, or a number of thin copper plates stacked in layers. The Patent Document 1 also describes that (2) in that superconducting coil cooling apparatus, another vibration-absorbing member, that is formed by a flexible tube such as a bellows tube, or a coil-like part, is provided between the refrigerator and a vacuum chamber of a cryostat, thereby preventing the vibration generated in the refrigerator from being transmitted to the vacuum chamber.

Japanese Patent Laid-Open Publication No. Hei 2-103346 (Patent Document 2) describes that an expander-displacer is attached to a compressor by a bellows to allow only low vibration.

Moreover, Japanese Patent Laid-Open Publication No. Hei 4-204280 (Patent Document 3) describes that, in a weak magnetic field measurement apparatus using a helium liquefier/refrigerator comprising a Joule-Thomson cycle (J-T cycle) and a pre-cooling cycle, (1) a vibration-blocking tube is provided for each of a hose forming the pre-cooling cycle and a hose forming the J-T cycle, and (2) an air suspension is provided between a member forming the pre-cooling cycle and a structure for supporting that member in order to isolate vibration of the pre-cooling cycle.

However, in the superconducting coil cooling apparatus described in Patent Document 1, the refrigerator and the superconducting coil connect with each other via a thermal shield receptacle provided in the vacuum chamber of the cryostat, a supporting bar for that thermal shield receptacle, and a coil supporting bar. Therefore, vibration transmitted through the supporting bars cannot be blocked.

Moreover, as in the technique described in Patent Document 2, in order to reduce vibration from the compressor and vibration caused by reciprocating motion of a piston that may be transmitted to the entire cryostat, the bellows may be included in the portion at which the cryostat is attached to the refrigerator. However, since the inside of the cryostat is kept vacuum, the bellows contracts and loses its flexibility. Therefore, the expected effect of attenuating vibration cannot be achieved.

Furthermore, in the apparatus described in Patent Document 3, the load of the cryostat is applied to the refrigerator. Therefore, vibration cannot be blocked sufficiently.

### SUMMARY OF THE INVENTION

The present invention was made in order to overcome the drawbacks of the aforementioned conventional techniques, and aims to prevent transmission of vibration which occurs due to the refrigerator to the entire cryostat and the object to be cooled.

According to the present invention, a cryogenic cooling apparatus including a cryostat that is cooled by using a refrigerator, includes: a support stage, to which a cold head of the refrigerator is secured, for supporting a load of the cold head, the support stage being provided separately from the cryostat; and a low-vibration stage, secured to the cryostat, for supporting a load of an object to be cooled, thereby achieving the above object of the present invention.

According to the present invention, it is possible to prevent transmission of vibration that occurs due to the refrigerator to the entire cryostat and the object to be cooled.

In the present invention, the entire cryostat may be placed on the ground (including a floor) or the support stage via a vibration-free mechanism. Thus, an effect of preventing vibration can be enhanced.

In the present invention, a compressor and the cold head that form the refrigerator may be connected by a flexible tube or a hose that is secured to the ground or a wall. Thus, the effect of preventing vibration can be enhanced.

The flexible tube or the hose at the cold-head side may be replaced with a rigid tube, and the rigid tube may be secured to a table provided separately from the cryostat, or the ground or the wall. Thus, the effect of preventing vibration can be enhanced.

In the refrigerator formed by the compressor and the cold head which includes a valve unit separable from the cold head, the valve unit may be secured to a table provided separately from the cryostat, or the ground or the wall. Thus, the effect of preventing vibration can be enhanced.

The cryostat and the support stage may be connected by a bellows so as to form a vacuum space together with a top flange of the cold head and a main body of the cryostat, thereby enhancing the effect of preventing vibration.

The bellows may be a welded bellows and a buffer member may be provided between crests of the bellows. Thus, vibration of the bellows can be prevented from oscillating.

The refrigerator may be a pulse tube refrigerator, a GM refrigerator or a Stirling refrigerator.

The present invention also provides a superconducting apparatus, a cryopump apparatus, a cryogenic measurement and analysis apparatus, and a nuclear magnetic resonance (NMR) apparatus, each of which includes the aforementioned cryogenic cooling apparatus.

The above and other novel features and advantages of the present invention are described in or will become apparent from the following detailed description of preferred embodiments.

### BRIEF DESCRIPTION OF THE DRAWINGS

The preferred embodiments will be described with reference to the drawings, wherein like elements have been denoted throughout the figures with like reference numerals, and wherein:

FIG. 1 is a cross sectional view showing the configuration of a cryogenic cooling apparatus according to a first embodiment of the present invention;

FIG. 2 is a cross sectional view showing the configuration of a cryogenic cooling apparatus according to a second embodiment of the present invention; and

FIG. 3 is a cross sectional view showing the configuration of a cryogenic cooling apparatus according to a third embodiment of the present invention.

### DETAILED DESCRIPTION OF THE PREFERRED EMBODIMENTS

Preferred embodiments of the present invention will be described in detail, with reference to the accompanying drawings.

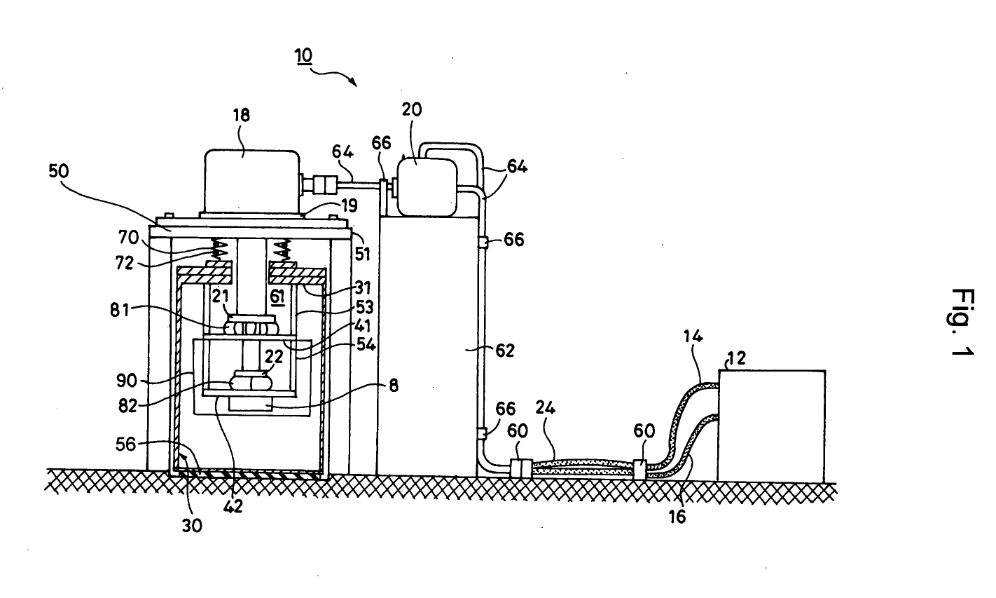

In a first embodiment as shown in FIG. 1, the present invention is applied to a cryogenic cooling apparatus using a two-stage GM pulse tube refrigerator, or a two-stage GM refrigerator (hereinafter, simply referred to as refrigerator) In this refrigerator 10, a valve unit 20 for switching a pressure of gas supplied from a compressor 12 of the refrigerator 10 to a cold head 18 via a high-pressure gas line 14 and a low-pressure gas line 16 can be separated from the cold head 18. The cold head 18 of the refrigerator 10 is not secured directly to a cryostat 30 but is secured to a support stage 50 that is provided separately from the cryostat 30. Thus, the support stage 50 supports the load of the cold head 18. Moreover, a second low-vibration stage 42, to which an object to be cooled 8 is secured and which supports the load of the object 8, is secured to the cryostat 30 (its top flange 31 in the example shown in FIG. 1) via supporting bars 53 and 54. As shown in FIG. 1, the cold head 18 includes a first cooling stage 21 and a second cooling stage 22.

The above support stage 50 is not necessarily a vacuum chamber. It is desirable that the support stage 50 have significantly large mass (30 kg or more, for example) and be installed on the ground independently of the cryostat 30.

The entire cryostat 30 is installed on the ground or a support stage via a vibration-free mechanism 56 formed by a rubber sheet, an air suspension, or a vibration-free structure, for example. In the example shown in FIG. 1, the entire cryostat 30 is installed on the ground via a rubber sheet.

Moreover, in order to prevent transmission of vibration of the compressor 12 to the entire cryostat 30, flexible tubes (or hose) 24 for connecting the compressor 12 and the cold head 18 are secured to the ground or a wall with a clamp 60.

In addition, the valve unit 20 is fixed to a table provided separately from the cryostat 30, the ground, or a wall. In the shown example, the valve unit 20 is fixed to a valve fixing table 62 having large mass (for example, 10 kg or more).

The flexible tube 24 is replaced in the vicinity of the valve unit 20 and the cold head 18, with a rigid tube 64 formed of stainless steel, copper, or the like. The rigid tube 64 is fixed to a table provided separately from the cryostat 30, the ground, or a wall with a clamp 66. In the shown example, the rigid tube 64 is fixed to the aforementioned valve fixing table 62.

Furthermore, a bellows 70 connects the cryostat 30 and the support stage 50 to each other, thereby forming a vacuum space 61 together with a top flange 19 of the cold head 18 and the main body of the cryostat 30. In the shown example, the bellows 70 connects the top flange 31 of the cryostat 30 and a top flange 51 of the supporting stage 50.

As the bellows 70 mentioned above, a welded bellows that is easy to deform and absorb vibration. A buffer member 72 such as a rubber sheet or a rubber ring, is provided between adjacent crests of the bellows 70, and therefore prevents oscillation of the bellows even when a shock or impact is externally applied thereto. Moreover, liquid may be included within the bellows 70 used as a double bellows, or a molded bellows may be used in place of the welded bellows.

In addition, flexible heat links 81 and 82 are provided between the first cooling stage 21 of the cold head 18 and the first low-vibration stage 41 and between the second cooling stage 22 and the second low-vibration stage 42, respectively, for the purpose of absorbing thermal contraction of the corresponding stages. The heat links 81 and 82 are formed by braided wires or thin plates of material having high thermal conductivity, such as copper or aluminum. Thus, while the flexibility is kept, thermal conductivity can be ensured.

In the present embodiment, the two-stage refrigerator is used. Thus, a thermal shield 90 is provided for the first low-vibration stage 41, thereby enhancing a cooling effect of the second low-vibration stage 42 on the lower-temperature side, to which the object to be cooled 8 is secured.

In this manner, it is possible to prevent vibration from the compressor 12 or that caused by reciprocating motion of a piston from being transmitted to the cryostat 30 by placing the load of the cold head 18 of the refrigerator 10 on the support stage 50 provided separately from the cryostat 30, instead of securing the cold head 18 of the refrigerator 10 directly to the cryostat 30.

Moreover, by supporting the load of the object to be cooled 8 by the cryostat 30 (its top flange 31 in the shown example) that receives less vibration, it is possible to prevent transmission of the vibration from the compressor 12 and that caused by the reciprocating motion of the piston to the object to be cooled 8 through a member for supporting the load of the object 8.

In addition, the entire cryostat 30 is installed on the ground or a support stage via the vibration-free mechanism 56. Thus, it is possible to make coupling between the cryostat 30 and the support stage 50 weaker, thereby preventing transmission of vibration to the entire cryostat 30 through the support stage 50.

Moreover, since the flexible tube 24 is secured to the ground or a wall by the clamp 60, the vibration from the compressor 12 can be blocked by the ground or the wall. Thus, the vibration from the compressor 12 is difficult to transmit to the entire cryostat 30.

Since the rigid tube 64 is used in the vicinity of the valve unit 20 and the cold head 18 and is secured to the table having large mass, provided separately from the cryostat 30, or the ground or the wall (to the valve fixing table 62 in the example shown in FIG. 1), pulsation of the flexible tube 24 caused by the pressure change of the compressor 12 can be reduced.

The valve unit 20 is secured to the table having large mass, provided separately from the cryostat 30, or the ground or the wall (to the valve fixing table 26 in the example shown in FIG. 1). Therefore, the vibration from the compressor 12 can be blocked more surely, and vibration generated by the valve unit 20 itself can also be blocked. Thus, those vibrations are difficult to transmit to the entire cryostat 30.

Moreover, the cryostat 30 (the top flange 31 thereof in the shown example) and the support stage 50 (the top flange 51 thereof in the shown example) are connected by the bellows 70. Therefore, it is possible to prevent the bellows 70 from losing its flexibility due to vacuum, thereby preventing transmission of the vibration from the compressor 12 and that caused by reciprocating motion of the piston to the cryostat 30.

A welded bellows is used as the bellows 70, and the buffer member 72 is provided between crests of the bellows. Thus, the effect of attenuating vibration, achieved by the bellows, can be further enhanced.

In addition, since the flexible heat links 81 and 82 are provided between the first cooling stage 21 of the cold head 18 and the first low-vibration stage 41 and between the second cooling stage 22 and the second low-vibration stage 42, respectively, it is possible to prevent vibration caused by the reciprocating motion of the piston and/or vibration caused by elastic expansion and contraction of the cylinder from being transmitted to the object to be cooled 8.

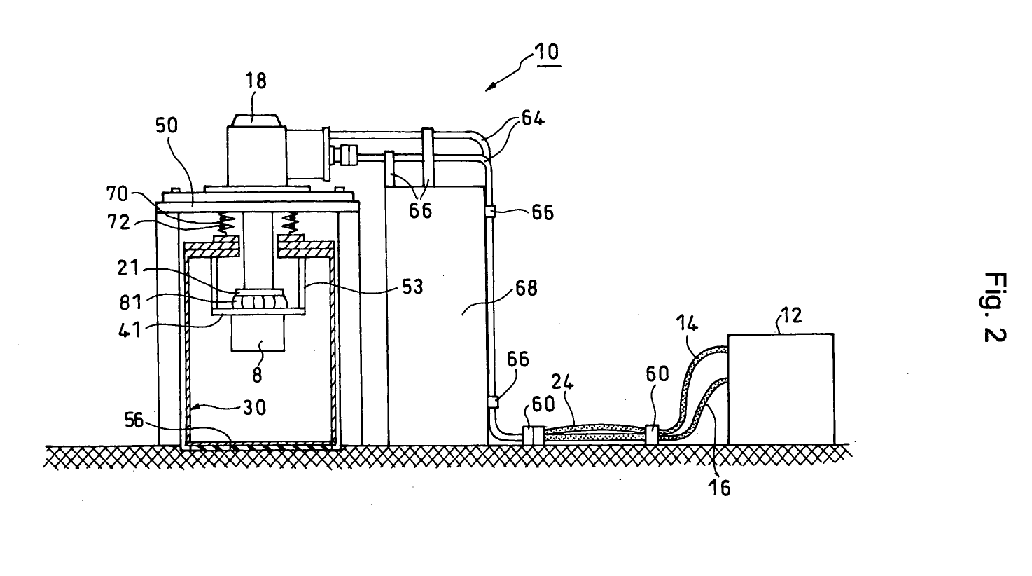

Next, a second embodiment of the present invention will be described with reference to FIG. 2. In the second embodiment, the present invention is applied to a cryogenic cooling apparatus using a single stage type GM refrigerator.

In the present embodiment, a switching valve and a driving motor are incorporated in the cold head 18. Thus, the high-pressure gas line 14 and the low-pressure gas line 16 are replaced with rigid tubes 64 formed of, for example, stainless steel, in the vicinity of the cold head 18. The rigid tubes 64 are fixed by clamps 66 to a connection tube fixing table 68, instead of the valve fixing table.

In addition, only the first low-vibration stage 41 is used as the low-vibration stage, and the second low-vibration stage 42, the supporting bar 54, the heat link 82, and the thermal shield 90 described in the first embodiment are omitted.

Except for the above, the present embodiment is the same as the first embodiment. Therefore, the description is omitted.

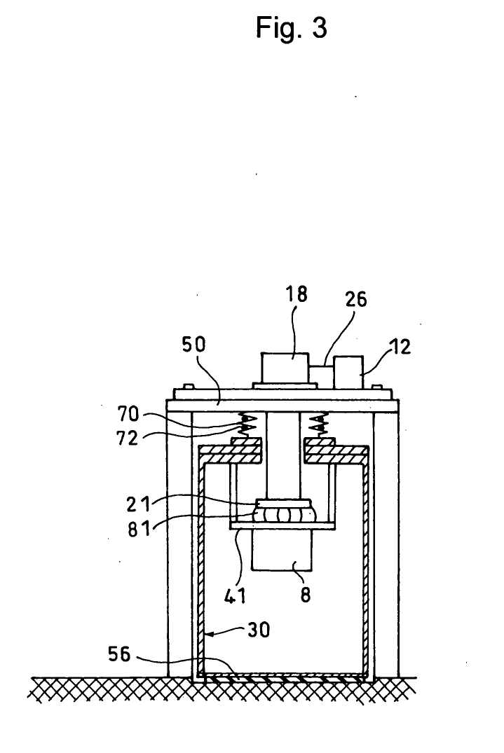

Next, a third embodiment of the present invention will be described, with reference to FIG. 3. In the third embodiment, the present invention is applied to a cryogenic cooling apparatus using a Stirling refrigerator or a stirling pulse tube refrigerator, in which the compressor 12 and the cold head 18 are integrated with each other or are arranged at a close range (within one meter) with each other via a connection pipe 26.

In the present embodiment, not only the cold head 18 but also the compressor 12 are secured to the support stage 50, as shown in FIG. 3. Thus, the support stage 50 supports both the load of the compressor 12 and that of the cold head 18.

Except for the above, the present embodiment is the same as the second embodiment. Thus, the further description of the present embodiment is omitted.

In the above embodiments, the GM pulse tube refrigerator is a two-stage type, while the other refrigerator is a single stage type. However, a combination of the number of stages and the type of the refrigerator is not limited to the above. Various combinations can be used.

The present invention can also be applied to a superconducting apparatus, a device cooling apparatus, a detector cooling apparatus, a sample cooling apparatus, a cryopump apparatus, a measurement and analysis apparatus, an NMR apparatus and the like, which require lower vibration.

The disclosure of Japanese Patent Application No. 2003-190886 filed on Jul. 3, 2003, including specification, drawings and claims is incorporated herein by reference in its entirety.

Although only a limited number of embodiments of the present invention have been described, it should be understood that the present invention is not limited thereto, and various modifications and variations can be made without departing form the spirit and scope of the invention defined in the accompanying claims.

1. A cryogenic cooling apparatus including a cryostat that is cooled by using a refrigerator, comprising:
a support stage, to which a cold head of the refrigerator is secured, for supporting a load of the cold head, the support stage being provided separately from the cryostat; and
a low-vibration stage, secured to the cryostat, for supporting a load of an object to be cooled.

2. The cryogenic cooling apparatus according to claim 1, wherein
the entire cryostat is placed on the ground or the support stage via a vibration-free mechanism.

3. The cryogenic cooling apparatus according to claim 1, wherein
a compressor and the cold head that form the refrigerator are connected by a flexible tube or a hose that is secured to the ground or a wall.

4. The cryogenic cooling apparatus according to claim 3, wherein
the flexible tube or the hose at the cold-head side is replaced with a rigid tube, which is secured to a table provided separately from the cryostat, or the ground or the wall.

5. The cryogenic cooling apparatus according to claim 1, wherein
the refrigerator is formed by a compressor and the cold head which includes a valve unit separable from the cold head, and the valve unit is secured to a table provided separately from the cryostat, or the ground or a wall.

6. The cryogenic cooling apparatus according to claim 1, wherein
the cryostat and the support stage are connected by a bellows so as to form a vacuum space together with a top flange of the cold head and a main body of the cryostat.

7. The cryogenic cooling apparatus according to claim 6, wherein
the bellows is a welded bellows and a buffer member is provided between crests of the bellows.

8. The cryogenic cooling apparatus according to claim 1, wherein
the refrigerator is a pulse tube refrigerator.

9. The cryogenic cooling apparatus according to claim 1, wherein
the refrigerator is a GM refrigerator.

10. The cryogenic cooling apparatus according to claim 1, wherein
the refrigerator is a Stirling refrigerator.

11. A superconducting apparatus comprising a cryogenic cooling apparatus comprising:
a support stage, to which a cold head of a refrigerator is secured, for supporting a load of the cold head, the support stage being provided separately from a cryostat; and
a low-vibration stage, secured to the cryostat, for supporting a load of an object to be cooled.

12. A cryopump apparatus comprising a cryogenic cooling apparatus comprising:
a support stage, to which a cold head of a refrigerator is secured, for supporting a load of the cold head, the support stage being provided separately from a cryostat; and
a low-vibration stage, secured to the cryostat, for supporting a load of an object to be cooled.

13. A cryogenic measurement and analysis apparatus comprising a cryogenic cooling apparatus comprising:
a support stage, to which a cold head of a refrigerator is secured, for supporting a load of the cold head, the support stage being provided separately from a cryostat; and
a low-vibration stage, secured to the cryostat, for supporting a load of an object to be cooled.

14. A nuclear magnetic resonance apparatus comprising a cryogenic cooling apparatus comprising:
a support stage, to which a cold head of a refrigerator is secured, for supporting a load of the cold head, the support stage being provided separately from a cryostat; and
a low-vibration stage, secured to the cryostat, for supporting a load of an object to be cooled.
